(19) United States
(12) Patent Application Publication
(10) Pub. No.: US 2015/0377178 A1
(43) Pub. Date: Dec. 31, 2015

(54) ENGINE CYLINDER COOLING CAVITY

(71) Applicant: General Electric Company, Schenectady, NY (US)

(72) Inventors: Frederic Bussieres, Innsbruck (AT); Johannes Karl Raitmair, Kematen (AT)

(21) Appl. No.: 14/319,435

(22) Filed: Jun. 30, 2014

(51) Int. Cl. F02F 1/16

(52) U.S. Cl. CPC F02F 1/16

(57) ABSTRACT

A system includes a cylinder liner for a reciprocating engine, where the cylinder liner has a piston bore configured to receive a piston. The cylinder liner includes a first end having a flange configured to interface with a cylinder head. Further, the system includes a cooling passage configured to receive a fluid to cool the cylinder liner, where a first portion of the cooling passage is defined by and disposed within the flange.

### BACKGROUND

The subject matter disclosed herein relates to reciprocating engines and, more specifically, to a cooling cavity and cylinder liner for a reciprocating engine.

A reciprocating engine (e.g., an internal combustion engine such as a diesel engine, gasoline engine, or gas engine) combusts fuel with an oxidant (e.g., air) in a combustion chamber to generate hot combustion gases, which in turn drive a piston (e.g., reciprocating piston) within a cylinder. In particular, the hot combustion gases expand and exert a pressure against the piston that linearly moves the position of the piston from a top portion (e.g., top dead center) to a bottom portion (e.g., bottom dead center) of the cylinder during an expansion stroke. The piston converts the pressure exerted by the hot combustion gases (and the piston's linear motion) into a rotating motion (e.g., via a connecting rod and a crank shaft coupled to the piston) that drives one or more loads, for example, an electrical generator. The combustion and friction between moving and stationary parts (e.g., cylinder and piston) generates heat, which can reduce the life of the parts, reduce performance, and increase maintenance frequency and costs. Despite thermal management efforts, thermal distortion is inherent to many reciprocating engine components, which leads to thermal stresses and can also lead to non-uniform wear of the parts.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In one embodiment, a system includes a cylinder liner for a reciprocating engine, where the cylinder liner has a piston bore configured to receive a piston. The cylinder liner includes a first end having a flange configured to interface with a cylinder head. Further, the system includes a cooling passage configured to receive a fluid to cool the cylinder liner, where a first portion of the cooling passage is defined by and disposed within the flange.

In another embodiment, a system includes a reciprocating engine. The reciprocating engine includes a cylinder liner and a piston disposed within the cylinder liner, where the piston is configured to move between a top dead center position and a bottom dead center position relative to the cylinder liner. The reciprocating engine also includes a cooling passage configured to receive a fluid to cool the cylinder liner above the top dead center position, at the top dead center position, and below the top dead center position.

In yet another embodiment, a system includes a cylinder liner for a reciprocating engine, where the cylinder liner has a piston bore configured to receive a piston, the cylinder liner has a first end having a flange configured to interface with a cylinder head, and the cylinder liner has an annular body portion extending away from the flange at the first end to a second end in a longitudinal direction relative to a longitudinal axis of the cylinder liner. The system also includes a cylinder block disposed about the cylinder liner and a continuous cooling passage that extends in both the longitudinal direction and a circumferential direction relative to the longitudinal axis within the flange, within a portion of the annular body, and between a cavity defined by both the cylinder liner and the cylinder block. Further, the system includes a plurality of structures within the continuous cooling passage.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of a prime mover or a power generation system;

FIG. 2 is a cross-sectional side view of an embodiment of a reciprocating or piston engine of the power generation system of FIG. 1 illustrating a piston reciprocating in a cylinder;

FIG. 3 is a perspective cutaway view of an embodiment of a cylinder liner and a cooling cavity;

FIG. 4 is an exploded side view of an embodiment of a cylinder block and cylinder liner having a sleeve with structures;

FIG. 5 is a partial cross-sectional side view of an embodiment of a cylinder block, a cylinder liner, and a cooling cavity;

FIG. 6 is a cross-sectional top view of an embodiment of a cylinder block, a cylinder liner, and a cooling cavity;

FIG. 7 is a perspective view of an embodiment of various connectors (e.g., acting as structural support beams and/or heat transfer fins) of a cylinder block, a cylinder liner, and a cooling cavity;

FIG. 8 is a top view of an embodiment of the connectors of FIG. 6, where the connectors are disposed in line in two cross-wise directions;

FIG. 9 is a top view of an embodiment of the connectors of FIG. 6, where the connectors are disposed in a staggered arrangement;

FIG. 10 is a cross-sectional top view of an embodiment of one connector, having a circular shape;

FIG. 11 is a cross-sectional top view of an embodiment of one connector, having a square shape;

FIG. 12 is a cross-sectional top view of an embodiment of one connector, having a rectangular shape;

FIG. 13 is a cross-sectional top view of an embodiment of one connector, having a triangular shape; and

FIG. 14 is a cross-sectional top view of an embodiment of one connector, having a tear drop shape or airfoil shape.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is directed to systems for cooling components of reciprocating engines. In particular, embodiments of the present disclosure include a reciprocating engine that includes a cylinder with a cylinder block, a cylinder liner, and an associated cooling cavity (e.g., cooling passageway, cooling path, cooling duct, etc.) configured to cool components of the reciprocating engine (e.g., the cylinder block, the cylinder liner, a piston of the reciprocating engine, etc.). In accordance with embodiments of the present disclosure, the cylinder liner may be disposed into a bore inside the cylinder block, where a gap between the cylinder liner and the cylinder block at least partially forms the associated cooling cavity (e.g., an annular cooling cavity around the cylinder liner and piston). The cooling cavity also extends and feeds into at least a portion of the cylinder liner. As such, a fluid may be routed through the cooling cavity for cooling components of the reciprocating engine adjacent the cooling cavity. In some embodiments, the cooling cavity (e.g., cooling passageway) may be a single continuous cooling passageway, such that the single continuous cooling passageway may be utilized to cool components (e.g., a scrapper ring, gasket, firedeck, etc.) from a variety of regions of the engine proximate the cylinder.

As indicated above, the cooling cavity may extend into the cylinder liner. For example, the cylinder liner may include a cylindrical, hollow or partially hollow liner body with a flange disposed above or at a mid-section of the liner body (e.g., at an end of the cylinder liner and/or at its mid span) and extending radially outward from the liner body. The flange may sit in a bore or recessed lip of the cylinder block to position the cylinder liner within the hollow inside of the cylinder block, where the cylinder block extends annularly around the cylinder liner. The flange may also interface with a cylinder head above the cylinder liner. The cooling cavity extends within the gap between the cylinder block and the liner body of the cylinder liner, leaving space for the cooling fluid domain (e.g., flow path). The fluid domain (e.g., flow path) extends to and feeds a portion of the cooling cavity also extending into the flange and other parts (e.g., the liner body) of the cylinder liner. As such, the flange of the cylinder liner and components of the reciprocating engine disposed adjacent to the flange may be cooled via fluid routed through the cooling cavity. In some embodiments, as indicated above, a portion of the cooling cavity may also extend into the liner body of the cylinder liner below the flange, where the portion of the cooling cavity may be in fluid communication with the gap between the cylinder liner and the cylinder block via a port. In other words, the cooling cavity may extend into a portion of the flange of the cylinder liner, a portion of the cylindrical liner body of the cylinder liner, and between the cylinder liner and the cylinder block. As such, fluid routed through the cooling cavity may provide improved cooling to the flange of the cylinder liner, the piston of the reciprocating engine, and other components of the reciprocating engine disposed adjacent the cooling cavity and, thus, disposed adjacent the cylinder liner.

Further, a plurality of connectors (e.g., structural support beams/heat transfer fins) may be disposed within the cooling cavity, where the connectors are configured to provide stiffness to the cylinder liner against gas pressure loads and/or a side force from the piston and to provide increased heat transfer due to a greater surface area, increased fluid mixing, and improved distribution of cooling fluid for more uniform heat transfer about the cylinder liner. The connectors may be distributed in a grid or pattern, which may be uniformly or non-uniformly arranged about the cylinder liner. The connectors may be radially oriented structures, such as radial fins or supports beams. The connectors may also be longitudinally oriented or circumferentially oriented with respect to a longitudinal axis of the cylinder block. Further, the connectors may be disposed in any portion of the cooling cavity. For example, the connectors may be disposed between the cylinder liner and the cylinder block. Further, in some embodiments, the connectors may be disposed in the portions of the cooling cavity extending into the flange of the cylinder liner and the liner body of the cylinder liner. Further still, the connectors may be disposed in inlets and/or outlets of the cooling cavity, which may extend through the flange of the cylinder liner, the liner body of the cylinder liner, and/or the cylinder block disposed radially outward from, and surrounding, the cylinder liner. The connectors may be in-line or staggered, depending on the embodiment, and the connectors may include one or more of a number of different geometric shapes. Geometric descriptions and orientations of embodiments of the connectors (e.g., radial structures) will be discussed in detail below with reference to later figures.

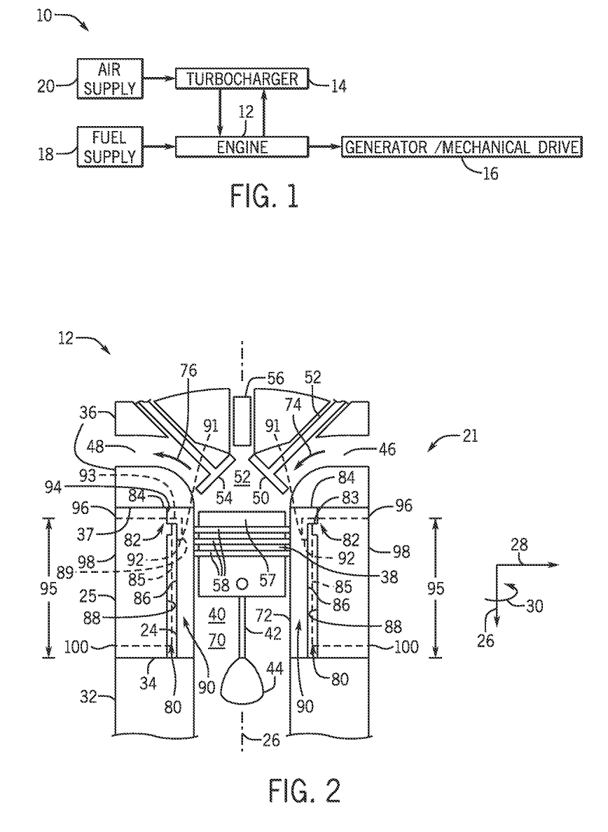

Turning now to the drawings and referring first to FIG. 1, a block diagram of an embodiment of an engine driven power generation system 10 with improved cooling capacity is illustrated. As described in detail below, the disclosed engine driven power system 10 utilizes an engine 12 that includes a wall of a cylinder (e.g., cylinder block) or a cylinder liner (e.g., disposed within the cylinder block) that includes an improved cooling cavity adjacent the cylinder liner. The engine 12 may include a reciprocating or piston engine (e.g., internal combustion engine). The engine 12 may include a spark-ignition engine or a compression-ignition engine. The engine 12 may include a natural gas engine, diesel engine, or any combustible fuel type. The engine 12 may be a two-stroke engine, three-stroke engine, four-stroke engine, five-stroke engine, or six-stroke engine. The engine 12 may also include any number of cylinders (e.g., 1-24 cylinders or any other number of cylinders) and associated piston and liners, for in-line or multi-bank cylinder arrangement.

The power generation system 10 includes the engine 12, a turbocharger 14, and a mechanical drive or generator 16. In other words, in embodiments including the mechanical drive, the power generation system 10 may actually be a prime mover to drive a compressor or some other type of machinery. Presently contemplated embodiments include both the power generation system 10 and the prime mover. For simplicity, the power generation system 10 will be described herein. Depending on the type of engine 12 of the power generation system 10, the engine receives fuel 18 (e.g., diesel, natural gas, coal seam gases, associated petroleum gas, etc.) and a pressurized oxidant 20, such as air, oxygen, oxygen-enriched air, or any combination thereof. Although the following discussion refers to the oxidant as the air 20, any suitable oxidant may be utilized with the disclosed embodiments. The fuel 18 and pressurized air 20 are fed into the engine 12. The engine 12 combusts a mixture of fuel 18 and air 20 to generate hot combustion gases, which in turn drive a piston (e.g., reciprocating piston) within a cylinder liner. In particular, the hot combustion gases expand and exert a pressure against the piston that linearly moves the piston from a top portion to a bottom portion of the cylinder liner during an expansion stroke. The piston converts the pressure exerted by the combustion gases (and the piston's linear motion) into a rotating motion (e.g., via a connecting rod and a crank shaft coupled to the piston). The rotation of the crank shaft drives the electrical generator 16 to generate power. In certain embodiments, exhaust from the engine 12 may be provided to the turbocharger 14 and utilized in a compressor portion of the turbocharger 14, thereby driving a turbine of the turbocharger 14, which in turn drives a compressor to pressurize the air 20. In some embodiments, the power generation system 10 may not include all of the components illustrated in FIG. 1. In addition, the power generation system 10 may include other components not shown in FIG. 1 such as control components and/or heat recovery components. In certain embodiments, the turbocharger 14 may be utilized as part of the heat recovery components. Further, the system 10 may generate power ranging from 10 kW to 10 MW. Besides power generation, the system 10 may be utilized in other applications such as those that recover heat and utilize the heat (e.g., combined heat and power applications), combined heat, power, and cooling applications, applications that also recover exhaust components (e.g., carbon dioxide) for further utilization, gas compression applications, and mechanical drive applications.

FIG. 2 is a cross-sectional side view of a portion of an embodiment of the reciprocating or piston engine 12 (or, more specifically, a cylinder 21 thereof) having a cylinder liner 24 disposed within a cylinder block 25. In the following discussion, reference may be made to longitudinal axis or axial direction 26, a radial axis or direction 28, and/or a circumferential axis or direction 30 of the engine 12. As mentioned above, in certain embodiments, the engine 12 may include multiple cylinders 21 (e.g., 2, 4, 6, 8, 10, 12, 14, 16, 18, 20, 22, or 24 cylinders 21), each including the cylinder liner 24 and the cylinder block 25, where the cylinder liner 24 is disposed within the cylinder block 25. In the illustrated embodiment, one cylinder 21 is shown having the cylinder block 25, the cylinder liner 24, a crankcase 32 coupled to a bottom end 34 of the cylinder liner 24 and the cylinder block 25, a cylinder head 36 coupled to a top end 37 of the cylinder liner 24 and the cylinder block 25, a piston 38 disposed in a cavity 40 (e.g., piston bore of the cylinder liner 24) radially inward from the cylinder liner 24, and a connecting rod 42 coupled to the piston 38 within the liner 24 and to a crankshaft 44 within the crankcase 32. In some embodiments, the crankcase 32 and the cylinder block 25 may be integral (e.g., a single structure). The cylinder head 36 includes an intake port 46 for receiving fuel or a mixture of fuel 18 and air 20 and an exhaust port 48 for discharging exhaust from the engine 12. An intake valve 50, disposed within the cylinder head 36 and the intake port 46, opens and closes to regulate the intake of fuel or the mixture of fuel and air into the engine 12 into a portion 52 (e.g., a combustion chamber) of the cavity 40 above the piston 12. An exhaust valve 54, disposed within the exhaust port 48, opens and closes to regulate the discharge of the exhaust from the engine 12. In certain embodiments (e.g., spark-ignition engine), a spark plug 56 (or a glow plug) extends through a portion of the cylinder head 36 and interfaces with the portion 52 of the cavity 40 where combustion occurs. A pre-chamber may also be present for enhancing combustion performance. In some embodiments (e.g., compression-ignition engine), the spark plug 56 is absent (or is replaced with a glow plug) and ignition occurs primarily due to compression of the mixture of air and fuel.

The piston 38 includes a crown 57 and a set of rings 58 disposed below the crown 57. The rings 58 may be configured to seal the portion 52 (e.g., combustion chamber) of the cavity 40, so that gases do not transfer into a portion 70 of the cavity 40 below the piston 38 into the crankcase 32. One or more of the rings 58 may also regulate the consumption of engine oil. In other words, in the illustrated embodiment, the rings 58 may physically contact and apply a side force against an inner surface 72 of the cylinder liner 24 as the piston 38 moves linearly along the longitudinal axis 26, as described below.

Opening of the intake valve 50 enables a mixture of fuel and air to enter the portion 52 (e.g., combustion chamber) of the cavity 70 above the piston 38 as indicated by arrow 74. With both the intake valve 50 and the exhaust valve 54 closed and the piston 38 near top dead center (TDC) (i.e., position of piston 38 furthest away from the crankshaft 44, e.g., near the top end 37 of the liner 24 and the cylinder block 25), combustion of the mixture of air and fuel occurs due to spark ignition (in other embodiments due to compression ignition). Hot combustion gases expand and exert a pressure against the piston 38 that linearly moves the position of the piston 38 from a top portion (e.g., at TDC) to a bottom portion of the cylinder liner 24 (e.g., at bottom dead center (BDC) in direction 26, which is the position of the piston 38 closest to the crankshaft 44, e.g., near the bottom end 34 of the liner 24 and the cylinder block 25) during an expansion stroke. The piston 38 converts the pressure exerted by the combustion gases (and the piston's linear motion) into a rotating motion (e.g., via the connecting rod 42 and the crank shaft 44 coupled to the piston 38) that drives one or more loads (e.g., the electrical generator 16). The exhaust valve 54 then opens and enables exhaust of the combustion gases through the exhaust port 48, as indicated by arrow 76, while the piston 38 moves upwardly toward TDC. As the piston 38 approaches and ultimately reaches approximately TDC, the intake valve 50 opens and enables the fuel to enter the portion 52 of the cavity 40 above the piston 38. The cavity 40 fills with fuel and air as the piston 38 moves downwardly toward BDC. The fuel and air is then compressed as the piston 38 moves upwardly toward TDC. The fuel-air mixture is ignited once the piston 38 reaches approximately TDC, and the process is repeated.

Heat is released from a number of sources in the engine 12 during operation. For example, heat is generated from combustion in the portion 52 (e.g., combustion chamber) of the cavity 40 above the piston 38. Further, heat is generated from the linear motion of the piston 38 in the cavity 40 and from friction between the rings 58 of the piston 38 and the inner surface 72 of the cylinder liner 24 as the piston 38 moves along the longitudinal axis 26 within the cavity 40. Further still, heat is generated from the rotational motion of the crankshaft 44 in the cavity. Accordingly, the cylinder liner 24, cylinder block 25, the piston 38, and other components of the engine 12 generally operate at elevated temperatures and can benefit from active and/or passive cooling of the engine 12. Thus, the cylinder liner 24 is disposed within the cylinder block 25 and used for cooling, where a cooling cavity 80 between the cylinder block 25 and the cylinder liner 24 and at least partially within the cylinder liner 24 itself is configured to cool components of the engine 12 via a flow of coolant.

For example, in the illustrated embodiment, the cylinder block 25 extends from an annular interface to the adjacent cylinder(s). The cylinder block 25 therefore encloses the cylinder liner 24 in the circumferential direction 30 around the longitudinal axis 26. In other words, the cylinder block 25 in the illustrated embodiment is a hollow or partially hollow, substantially cylindrical structure. The cylinder block 25 includes a bore 82 with a horizontal annular surface 83 on which a flange 84 of the cylinder liner 24 rests. Thus, the cylinder liner 24 sits within the cylinder block 25, and a portion 85 of the cooling cavity 80 may substantially reside between an outer surface 86 (e.g., outer cylindrical surface) of the cylinder liner 24 and an inner surface 88 (e.g., inner cylindrical surface) of the cylinder block 25, where both the outer surface 86 and the inner surface 88 extend annularly in the circumferential direction 30 about the longitudinal axis 26. The portion 85 of the cooling cavity 80 between the cylinder liner 24 and the cylinder block 25 may extend longitudinally 26 through and circumferentially 30 (e.g., 360 degrees circumferentially 30) about the cylinder liner 24 (e.g., an annular cooling cavity).

Further, a portion 89 of the cooling cavity 80 may extend into a cylindrical liner body 90 of the cylinder liner 24, where the liner body 90 extends longitudinally (e.g., in the longitudinal direction 26) away from the flange 84. The portion 89 of the cooling cavity 80 may extend circumferentially 30 (e.g., 360 degrees circumferentially 30) about the liner body 90 of the cylinder liner 24 and longitudinally 26 through the liner body 90. For example, in the illustrated embodiment, the liner body 90 extends annularly (e.g., circumferentially 30) about the longitudinal axis 26 between the crankcase 32 and the cylinder head 36, where the flange 84 extends radially 28 away from the longitudinal axis 26 at a very top of the cylindrical liner body 90. The portion 89 of the cooling cavity 80 within the liner body 90 may include a longitudinal segment 91 and radial segment 92, where the radial segment 92 extends from between the cylinder liner 24 and the cylinder block 25 to the longitudinal segment 91 (e.g., in radial direction 28), and the longitudinal segment 91 extends from the radial segment 92 upwardly toward the flange 84 of the cylinder liner 24 (e.g., in the longitudinal direction 26). In some embodiments, the portion 89 of the cooling cavity 80 within the liner body 90 may extend in the longitudinal direction 26 through a greater portion of the liner body 90 of the cylinder liner 24 than is shown. For example, in some embodiments, as compared with a total length 95 of the liner body 90, the longitudinal segment 91 of the portion 89 of the liner body 90 may be in the range of approximately 1 to 99 percent of the length 95, approximately 2 to 75 percent of the length 95, approximately 3 to 50 percent of the length 95, approximately 4 to 25 percent of the length 95, or approximately 5 to 20 percent of the length 95. Such embodiments will be described in detail below with reference to later figures.

As indicated above, a portion 93 of the cooling cavity 80 may also reside within the flange 84 of the cylinder liner 24, where the portion 93 extends radially 28 inward through the flange 84 and circumferentially 30 (e.g., 360 degrees circumferentially 30) about the flange 84. The portion 93 may be configured to cool components at or above the top dead center position, as previously described, which is approximately at the top end 37 of the cylinder liner 24 within the cavity 40. Further, the portion 93 may extend longitudinally through the flange 84 until it couples with the portion 89 of the cooling cavity within the cylinder liner body 90 of the cylinder liner 24. The portion 93 within the flange 84 in the illustrated embodiment extends in the radial direction 28 away from the longitudinal axis 26, out of a side 94 of the liner body 90 below the flange 84 of the cylinder liner 24, and into the cylinder block 25. From there, the cooling cavity 80 may extend radially outward in direction 28 through the cylinder block 25, where it culminates in a port 96 (e.g., inlet) on an outer surface 98 of the cylinder block 25. In some embodiments, the portion 93 of the cooling cavity 80 within the flange 84 may also be considered a part of the port 96 (e.g., inlet). The cooling cavity 80 may also extend radially (e.g., in the radial direction 28) at the bottom 34 of the cylinder liner 24 (e.g., adjacent the crankcase 32) and through the cylinder block 25 (or crankcase 32, if the cylinder block 25 and crankcase 32 are a single integrated structure) culminating in another port 100. In some embodiments, the port 96 is an outlet and the port 100 is an inlet. In other embodiments, the port 96 is an inlet and the port 100 is an outlet. It should be noted that the flow within the cooling cavity 80 is driven by a pressure difference between at least two zones of the cooling cavity 80. Thus, the pressure at two or more given locations in the cooling cavity 80 may dictate the inlet and outlet locations. As such, the inlet(s) and outlet(s) may be disposed at suitable locations along the cylinder liner 24 to facilitate the flow of the fluid through the cooling cavity 80, given the pressure conditions described above.

In further embodiments, both of the ports 96, 100 may function as an inlet and an outlet depending on specific conditions of operation. For example, at one point in time during operation, cooling fluid (e.g., water or water-based coolant(s)) may be routed to the cooling cavity 80 through the port 96 and out of the cooling cavity 80 through the port 100. At another point in time during operation, fluid may be routed to the cooling cavity 80 through the port 100 and out of the cooling cavity 80 through the port 96. Which of the ports 96, 100 is used as the outlet and which of the ports 96, 100 is used as the inlet may be determined based on which portion of the cylinder block 25, cylinder liner 24, and/or piston 38, among other components, is in need of the most cooling. By way of non-limiting example, if components of the engine 12 adjacent the flange 84 of the cylinder liner 24 are in need of improved cooling, fluid may be routed to the cooling cavity 80 through the port 96, such that the fluid is coolest as it approaches the flange 84. Alternatively, if components of the engine 12 adjacent the crankcase 32 are in need of improved cooling, fluid may be routed to the cooling cavity through the port 100, such that the fluid is coolest as it approaches the cylinder liner 24 adjacent the crankcase 32.

In some embodiments, each of the ports 96, 100 may actually include a number of ports disposed circumferentially 30 about the cylinder block 25. For example, the port 96 may include 1, 2, 3, 4, 5, 6, 7, 8, or more ports 96 disposed circumferentially 30 about the longitudinal axis 26, where each of the ports 96 enables fluid communication through the cylinder block 25, through the flange 84 of the cylinder liner 24, through the cylindrical liner body 90 of the cylinder liner 24, and through the portion 85 of the cooling cavity 80 between the cylinder block 25 and the cylinder liner 24. Further, the port 100 may include 1, 2, 3, 4, 5, 6, 7, 8, or more ports 100 disposed circumferentially 30 about the longitudinal axis 26, where each of the ports 100 enables fluid communication through the cylinder block 25 and through the portion 85 of the cooling cavity 80 between the cylinder block 25 and the cylinder liner 24. In some embodiments, the ports 96 and the ports 100 may be evenly spaced circumferentially 30 about the longitudinal axis 26. In other embodiments, the ports 96 and the ports 100 may not be evenly spaced circumferentially 30 about the longitudinal axis 26. The ports 96, 100, and the cooling cavity 80 in general, will be discussed in further detail below with reference to later figures.

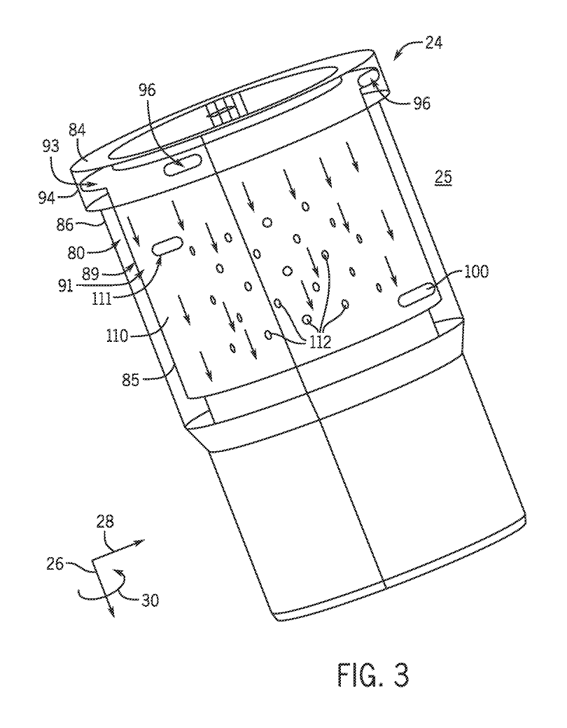

Turning now to FIG. 3, a cutaway perspective view of an embodiment of a portion of the cylinder liner 24 is shown. The cooling cavity 80 is illustrated entirely within the cylinder liner 24, but the cooling cavity 80 may also be disposed between or defined by the illustrated cylinder liner 24 and the cylinder block 25 (shown in FIG. 2) disposed radially outward from and surrounding the cylinder liner 24, as described above. In other words, the illustrated embodiment shows the portion 89 of the cooling cavity 80 within the liner body 90 of the cylinder liner 24 and the portion 93 of the cooling cavity 80 within the flange 84 of the cylinder liner 24. In the illustrated embodiment, fluid 110 is shown being routed through the cooling cavity 80, where the cooling cavity 80 resides within the cylinder liner 24. Further, the cooling cavity 80 is in fluid communication with the ports 96, 100 which, in the illustrated embodiment, are shown culminating at the outer surface 86 of the cylinder liner 24. In the illustrated embodiment, the fluid 110 is shown flowing downwardly in the longitudinal direction 26, such that the port 96 is an inlet and the port 100 is an outlet. In another embodiment, the fluid 110 may flow upwardly in the longitudinal direction 26, such that the port 96 is an outlet and the port 100 is an inlet. Indeed, the flow direction inside the cooling cavity 80 may have longitudinal and/or circumferential directions.

The cooling cavity 80 may also include portions extending through the cylinder block 25 (not shown), and the ports 96, 100 may thus be disposed in fluid communication with those portions and on an outside of the cylinder block 25. Further, the cooling cavity 80 may include an additional port 111, where the port 111 is disposed between (e.g., along the longitudinal axis 26) port 96 and port 100. The port 111 may be included as an additional inlet or outlet, depending on the embodiment, for supplying or discharging, respectively, fluid 110 within a portion of the cooling cavity 80 to another portion of the cooling cavity 80 or to a source external to the cooling cavity 80. In other words, one or more of the ports 96, 100, 111 may be in fluid communication with the portion 85 of the cooling cavity 80 that resides between the cylinder liner 24 and the cylinder block 25, which is not shown in the illustrated embodiment but will be discussed below with reference to later figures. Further, one or more of the ports 96, 100, 111 may be configured to import and/or export the fluid 110 to and/or from, respectively, the cooling cavity 80.

In the illustrated embodiment, connectors 112 (e.g., structures, radial structures, supports, etc.) are disposed within the cooling cavity 80 within the cylinder liner 24. For example, the connectors 112 may be structural support beams and/or heat transfer fins, which extend in the radial direction 28. The connectors 112 may be configured to improve uniformity of heat transfer circumferentially 30, radially 28, longitudinally 26, or a combination thereof, about the cylinder liner 24. The connectors 112 may be disposed in any portion of the cooling cavity 80, including portions in the liner body 90 of the cylinder liner 24 and/or the flange 84 of the cylinder liner 24, and the connectors 112 may be uniformly or non-uniformly distributed about the cooling cavity 80.

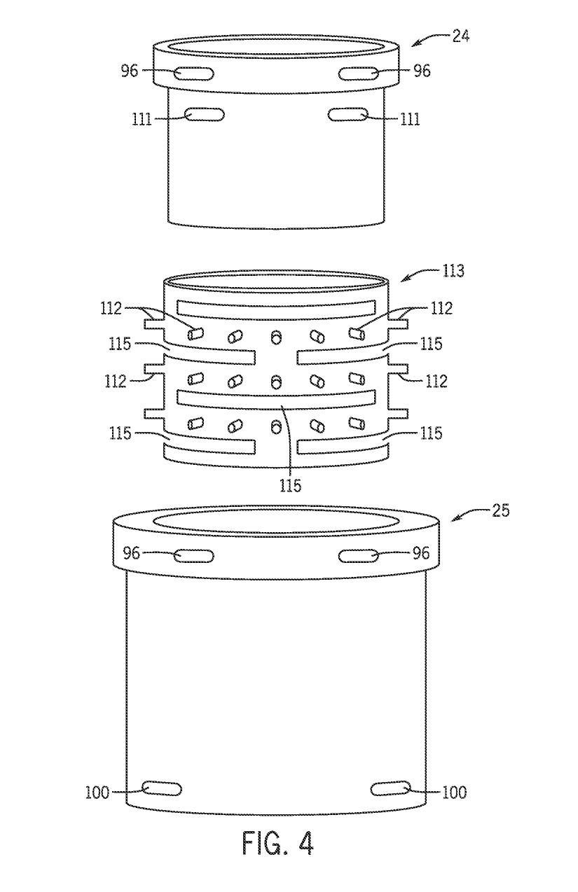

Further, in embodiments where portions (e.g., the portion 85) of the cooling cavity 80 are included between the cylinder liner 24 and the cylinder block 25, the connectors 112 may be disposed between the cylinder liner 24 and the cylinder block 25, where the connectors 112 are coupled to the outer surface 86 of the cylinder liner 24, the inner surface 88 of the cylinder block 25, or both. In other words, the connectors 112 may extend within any portion(s) of the cooling cavity 80 in accordance with the present disclosure. Further, in some embodiments, the connectors 112 may be a portion of another component, such that heat transfer through the connectors 112 may be transferred to a component other than the cylinder liner 24 or cylinder block 25, e.g., to the component including the connectors 112. For example, an embodiment of the connectors 112 is shown in an exploded side view in FIG. 4. In the illustrated embodiment, the connectors 112 are intended to be disposed external to the cylinder liner 24 (e.g., between the cylinder liner 24 and the cylinder block 25). A sleeve 113 bearing the connectors 112 may be inserted between the cylinder liner 24 and the cylinder block 25, such that heat may be transferred away from the cylinder liner 24 and to the sleeve 113. The sleeve 113 may also be coupled to a heat sink external to the cylinder, such that heat may be transferred from the sleeve 113 to the external heat sink. The sleeve 113 may be bonded, brazed, or press fit in order to maximize the thermal conductance via the contact. In some embodiments, the sleeve 113 may also include openings 115 between rows of connectors 112 to reduce materials cost for producing the sleeve 113. One or more of the openings 115 may also line up with one or more of the ports 96, 100, 111 to enable fluid to flow there through. In some embodiments, the sleeve 113 may not include openings 115, such that more material is used for more convective heat transfer. Further, the sleeve 113 may include a different material than the cylinder liner 24 and/or cylinder block 25, where the material may be selected to enhance heat transfer.

In some embodiments (e.g., with or without the sleeve 113), the connectors 112 may be configured to provide stiffness to the cylinder liner 24, the cylinder block 25, and other components of the engine 12 (or cylinder thereof) from gas pressure and a side force (e.g., radial 28 force) exerted against the cylinder liner 24 by the piston 38 or the rings 58 of the piston 38, where the piston 38 resides radially inward (e.g., in direction 28) from the cylinder liner 24 in the illustrated embodiment. To provide increased stiffness, the connectors 112 may be distributed in grid, which may include the connectors 112 arranged in a uniform or non-uniform manner. The grid of connectors 112 may include approximately 100 to 10000 connectors 112, approximately 200 to 5000 connectors 112, or approximately 300 to 1000 connectors 112.

Further, the connectors 112 may be configured to swirl the fluid 110 traveling through the cooling cavity 80 to mix the fluid 110 and evenly distribute heat extracted from the engine 12 by the fluid 110. As such, the connectors 112 may improve heat exchange between the fluid 110 and components (e.g., the piston 38) of the engine 12 by increasing turbulence in the flow. Specific geometries and orientations of the connectors 112 will be discussed in detail with reference to later figures. The connectors 112 may also provide improved convective heat transfer due to an increased surface area/volume of the cylinder liner 24 and cylinder block 25 (e.g., together with the connectors 112). For example, the fluid 110 flowing through the cooling cavity 80 may contact an increased surface area due to the connectors 112 disposed in the flow of the fluid 110, such that the fluid 110 extracts a greater amount of heat. Further, the connectors 112 may provide improved convective heat transfer from the cylinder liner 24 to the cylinder block 25. In other words, with increased surface area (e.g., of the cylinder liner 24 and cylinder block 25 together with connectors 112), volumetric heat content within the cylinder liner 24 and cylinder block 25 (e.g., together with the connectors 112) may be reduced due to improved thermal management.

Another embodiment of the cooling cavity 80, the cylinder block 25, and the cylinder liner 24 is shown in a partial cross-sectional side view in FIG. 5. The illustrated embodiment includes the structures 112 disposed within the flange 84 of the cylinder liner 24, a portion of the liner body 90, and between the cylinder liner 24 and the cylinder block 25. The illustrated structures are disposed on the outer surface 86 of the cylinder liner 24 (e.g., without a separate sleeve 113). The cooling cavity 80 is shown extending through the gap between the cylinder block 25 and the cylinder liner 24 as well as through the flange 84 and the liner body 90 of the cylinder liner 24. In the illustrated embodiment, the longitudinal segment 91 of the portion 89 of the cavity 80 extending through the liner body 90 of the cylinder liner 24 extends through approximately 60 to 90 percent of the length 95 of the liner body 90. Depending on the embodiment, as previously described, the longitudinal segment 91 of the portion 89 of the cavity 80 may extend from the flange 84 of the cylinder liner 24 through approximately 1 to 99 percent of the length 95 of the cylinder body 90, approximately 2 to 75 percent of the length 95, approximately 3 to 50 percent of the length 95, approximately 4 to 25 percent of the length 95, or approximately 5 to 20 percent of the length 95. Further, the portion 89 of the cooling cavity 80 extending through the liner body 90 is coupled with the cooling cavity 80 via the ports 111, as previously described. The ports 96 and 100 extend through the cylinder block 25, such that the fluid 110 may be routed through the ports 96 and 100, in either direction depending on the embodiment, and into or out of the cooling cavity 80. The cooling cavity 80, as described above, includes connectors 112 which are configured to provide stiffness to the cylinder liner 24, to swirl the fluid 110 within the cooling cavity 80 for improved heat distribution, and to provide an increased surface area for increased convective heat transfer, as described above.

As previously indicated, the connectors 112 may be radially oriented structures, such as structural support beams and/or heat transfer fines. The connectors 112 may be symmetrical (e.g., cylindrical) or asymmetrical (e.g., airfoil shape) to help mix and or control the fluid flow. The connectors 112 also may define a grid of connectors 112 that are spaced apart from one another (e.g., uniformly or non-uniformly) in the axial direction 26, the circumferential direction 30, and/or the longitudinal direction 26.

In the illustrated embodiment, the portion 85 of the cooling cavity 80 between the cylinder block 25 and the cylinder liner 24 is directly below a lip 114 (e.g., annular lip) of the cylinder block 25. The flange 84 (e.g., annular flange) of the cylinder liner 24 rests on a top surface 116 of the lip 114 (e.g., annular lip), where the lip 114 extends radially inward (e.g., toward the longitudinal axis 26) from the inner surface 88 of the cylinder block 25. Further, an outer surface 118 of the flange 84 (e.g., annular flange) of the cylinder liner 24 is substantially even with the inner surface 88 of the cylinder block 25, as measured in the radial direction 28 from the longitudinal axis 26. In another embodiment, the outer surface 118 of the flange 84 (e.g., annular flange) may not be substantially even with the inner surface 88 of the cylinder block 25. For example, the inner surface 88 of the cylinder block 25, in another embodiment, may be substantially even with an outer surface 119 of the lip 114, such that the cylinder block 25 actually includes a bore instead of the lip 114, where the flange 84 of the cylinder liner 24 rests within the bore. It should be noted that, in some embodiments, a seal may be disposed between the cylinder liner 24 and the cylinder block 25 along the lip 114. For example, a seal may be disposed proximate the outer surface 118 of the flange 84 for sealing the contact between the cylinder liner 24 and the cylinder block 25, such that the coolant does reach a gasket of the cylinder head 36 or leak around the lip 114.

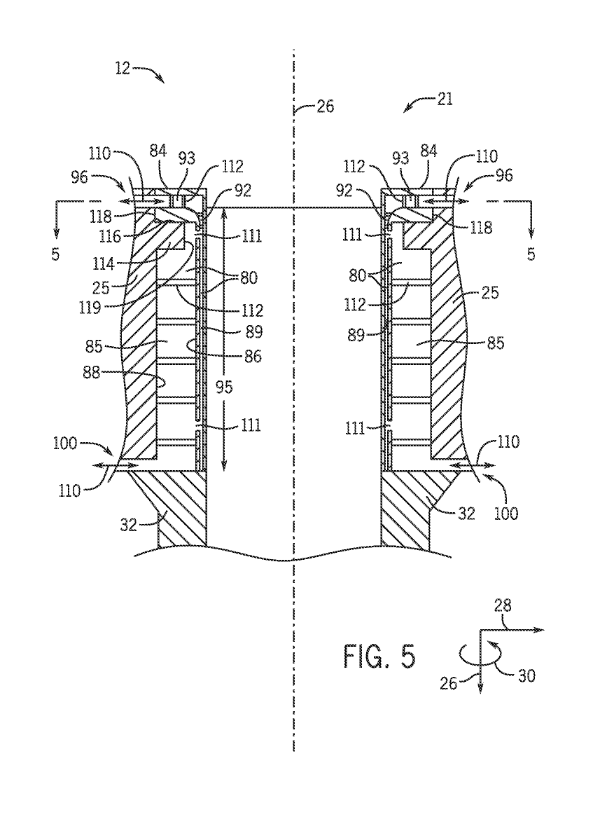

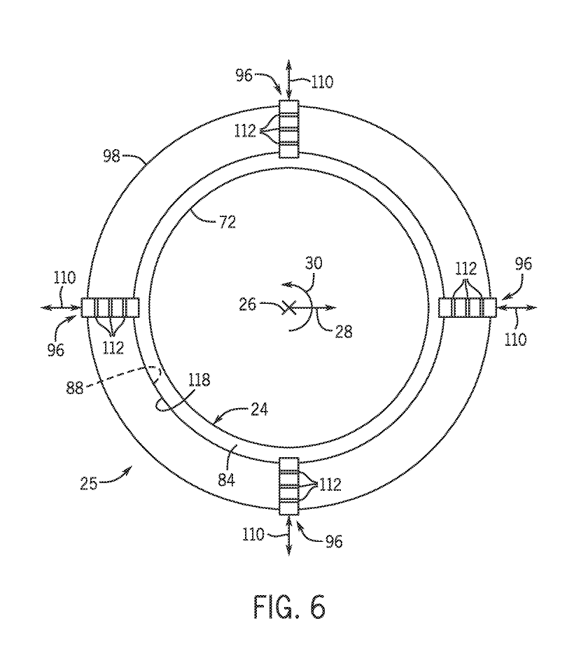

An embodiment of the cooling cavity 80, the cylinder block 25, and the cylinder liner 24 is shown in a cross-sectional top view in FIG. 6, taken along lines 5-5 in FIG. 5. In the illustrated embodiment, four ports 96 are shown disposed on the outer surface 98 of the cylinder block 25 with even spacing between each of the four ports 96. The ports 96 are disposed on the outer surface 98 of the cylinder block 25, such that the fluid 110 may be routed into the cooling cavity 80 via the ports 96 or out of the cooling cavity 80 via the ports 96, depending on the embodiment. The ports 96 are coupled to the portion 93 of the cooling cavity 80 disposed within the flange 84 of the cylinder liner 24. The flange 84 of the cylinder liner 24 is shown as resting on the horizontal annular surface 83 of the bore 82 of the cylinder block 25, such that the cylinder liner 24 is positioned within the cylinder block 25. The space (e.g., portion 85) between the cylinder liner 24 and the cylinder block 25, as previously described, serves as at least a portion of the cooling cavity 80 (e.g., portion 85), in conjunction with the portion 93 of the cooling cavity 80 extending through the flange 84, as described above, and the portion 89 of the cooling cavity 80 disposed within the liner body 90 of the cylinder liner 24 (not shown due to perspective of illustration). In other words, in the illustrated embodiment, the fluid 110 may enter, for example, the ports 96, flow through the portion 93 of the cooling cavity 80 disposed within the flange 84, downwardly (e.g., in direction 26) and circumferentially (e.g., in direction 30) through the cylinder liner 24 (e.g., the flange 84 and the liner body 90 of the cylinder liner 24), and between the cylinder liner 24 and the cylinder block 25. The connectors 112 may be disposed in any portion of the cooling cavity 80, and may, depending on the location, provide stiffness to the cylinder liner 24 while also improving heat transfer to the fluid 110. For example, the connectors 112 may increase the surface area for heat transfer, increase mixing, and help to swirl the fluid 110 for improved heat distribution and, thus, improved heat transfer, as described above.

In the illustrated embodiment, as described above, four ports 96 are disposed evenly about the circumference of the outer surface 98 of the cylinder block 25. The number of ports 96 may vary depending on the embodiment. For example, there may be 1, 2, 3, 4, 5, 6, 7, 8, 9, 10, 11, 12 or more ports 96 disposed along the circumference (e.g., the outer wall 98) of the cylinder block 25, where each of the ports 96 is in fluid communication with the portion 93 of the cooling cavity 80 that extends through the cylinder block 25 and through the flange 84 of the cylinder liner 24. In the illustrated embodiment, the ports 96 are evenly spaced about the outer wall 98 of the cylinder block 25. However, in another embodiment, the ports 96 may not be evenly spaced. For example, the ports 96 and accompanying portions 93 of the cooling cavity 80 may be selectively placed next to portions of the cylinder block 25 and cylinder liner 24, respectively, that endure higher thermal loads than the other portions of the cylinder block 25 and cylinder liner 24 (e.g., near combustion region). Beside the pure radial direction 28 of the flow in the inlet and outlet areas, the ports 96, 100 may also have a circumferential component in order to enable higher flow velocity in the cavity 80. Further, the description above applies to the ports 100 (not shown due to perspective) disposed at the bottom end 34 of the cylinder liner 24 and cylinder block 25, and to the ports 111 (not shown due to perspective) configured to enable fluid communication between the portion 89 of the cooling cavity 80 within the cylinder liner 24 and the portion 85 of the cooling cavity 80 between the cylinder liner 24 and the cylinder block 25 (e.g., the ports 111 that, in FIG. 5, do not extend into or through the cylinder block 25). In some embodiments, the ports 111 may also extend through the cylinder block 25, similar to the ports 96 and 100.

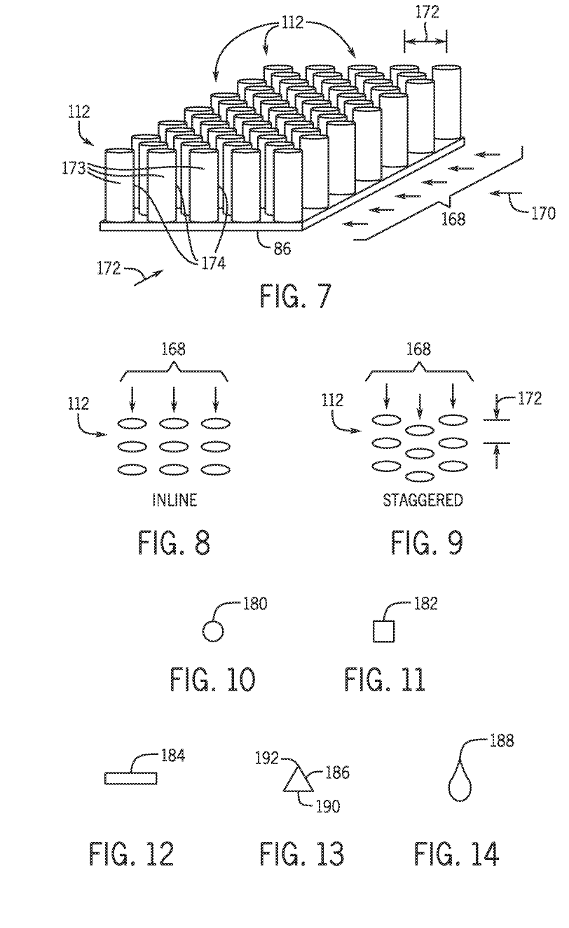

Turning now to FIG. 7, a perspective view of a schematic of a plurality of the connectors 112 (e.g., in a grid or pattern or spaced out configuration) coupled to a surface (e.g., the outer surface 86 of the cylinder liner 24) of the engine 12 (or, more specifically, of one of the cylinders 21 of the engine 12) is shown. In some embodiments, the connectors 112 may be disposed on a different surface, e.g., the inner surface 88 of the cylinder block 25 or one of the surfaces of the cylinder liner 24 defining the portion 89 of the cooling cavity 80 within the cylinder liner 24. As previously described, in some embodiments, the connectors 112 are configured to provide stiffness to the cylinder liner 24, the cylinder block 25, and other components of the engine 12. Further, the connectors 112 are configured to swirl the fluid 110 circulating through the cooling cavity 80 to substantially evenly distribute heat extracted by the fluid 110 through the fluid 110. Further still, the connectors 112 are configured to provide an increased surface area for enhanced convective heat transfer, as previously described.

In the illustrated embodiment, the connectors 112 are disposed on the outer surface 86 of the cylinder liner 24. For example, the connectors 112 are integral or integrally formed with the outer surface 86 of the cylinder liner 24. However, the connectors 112 may be coupled to the outer surface 86 in some other manner, for example, via fasteners, welds, adhesive, interference fits, or some other coupling device. Further, the connectors 112 (e.g., structures) may be spaced apart and located 360 degrees circumferentially 30 about the cylinder liner 24. In another embodiment, the connectors 112 may be disposed on a different surface of the engine 12, such that the connectors 112 are disposed within a flow path of the fluid 110 through the cooling cavity 80. For example, in one embodiment, the connectors 112 are disposed on the inner surface 88 of the cylinder block 25.

In some embodiments, the connectors 112 may span through the entire cross-sectional area of the portion of the cooling cavity 80 that the connectors 112 are disposed in, with respect to the flow of the fluid 110 through the cooling cavity 80. For example, with reference to previous figures, the connectors 112 may extend in the radial 28 direction from the inner surface 88 of the cylinder block 25 to the outer surface 86 of the cylinder liner 24 (e.g., across the entire radial gap), and the connectors 112 may be distributed throughout the entire cross-sectional area of the cooling cavity 80 disposed between the cylinder block 25 and the cylinder liner 24, with respect to the fluid 110 flowing, for example, downwardly in direction 26. Each of the connectors 112 may fully extend through the entire cross-sectional area of the portion 89 of the cooling cavity 80 disposed within the liner body 90 of the cylinder liner 24, with respect to the flow of the fluid 110, for example, downwardly in direction 26. In other words, the connectors 112 may extend between and physically interface with (e.g., contact) both the cylinder liner 24 and the cylinder block 25. In some embodiments, however, the connectors 112 may be disposed on only one surface (e.g., the inner surface 88 of the cylinder block 25 or the outer surface 86 of the cylinder liner 24), and may extend toward another surface (e.g., the outer surface 86 of the cylinder liner 24 or the inner surface 88 of the cylinder block 25) but not contact the other surface. Alternatively, the connectors 112 may be disposed on and coupled to one surface and contact another surface, but may not be coupled to the other surface.

Further, the connectors 112 may be oriented and/or placed into a number of different configurations (e.g., grids, patterns, or spaced arrangements). For example, continuing with the illustrated embodiment, the connectors 112 are disposed into rows 168, where each row 168 extends in direction 170. In the illustrated embodiment, every other row 168 is offset a distance 172 in direction 170. Accordingly, a flow path of the fluid 110 in direction 172 would result in the fluid 110 encountering staggered connectors 112, where the flow of the fluid 110 is perpendicular to a broad side 173 of each connector 112. In another embodiment, the broad side 173 of the connectors 112 may face the same direction as in the illustrated embodiment, but the connectors 112 may be disposed in rows that extend in direction 172, where every other row is offset a distance in direction 172, as opposed to direction 170. Accordingly, a flow path of the fluid 110 in direction 170 would result in the fluid 110 encountering staggered connectors 112, where the flow of the fluid 110 is parallel with the broad sides 173 of the connectors 112. In other words, in such an embodiment, the fluid 110 would encounter a thin side 174 of the staggered connectors 112. In the illustrated embodiment, the fluid 110 would encounter the broad sides 173 of the staggered connectors 112.

In other embodiments, the connectors 112 may be disposed inline (e.g., not staggered). For example, in FIG. 8, the connectors 112 are illustrated inline, where each of the rows 168 lines up with the other rows. In other words, the connectors 112 in FIG. 8 are distributed inline in both cross-wise directions, which may be axial and circumferential directions. For example, the connectors 112 (e.g., structures) may be disposed between the cylinder liner 24 and the cylinder block 25, and the connectors 112 (e.g., structures) may be disposed into in-line rows in the circumferential 30 direction and into in-line rows in the longitudinal direction 26. In FIG. 9, however, as described with respect to the embodiment in FIG. 7, the rows 168 of the connectors 112 are staggered by distance 172 (e.g., in either the circumferential direction 30 or the longitudinal direction 26). For example, the connectors 112 in FIG. 9 are in-line in one cross-wise direction and staggered (e.g., by distance 172) in the other cross-wise direction.

Further, the shape of the connectors 112 may vary depending on the embodiment. Different embodiments of a single connector 112 are shown in cross-sectional top views in FIGS. 10-14. Some embodiments include cross-sectional shapes that are symmetrical about an axis, while other embodiments include cross-sectional shapes that are asymmetrical about the axis. For example, each of the connectors 112 may include a cross-sectional shape of, e.g., a circle 182 (FIG. 10), a square 182 (FIG. 11), a rectangle 184 (FIG. 12), a triangle 186 (FIG. 13), a tear drop or air foil shape 188 (FIG. 14), or some other shape (e.g., an oval, an ellipse, etc.). In some embodiments, the cross-sectional shape and disposition of the connectors 112 may vary within the cooling cavity 80.

Further, the connector 112 may be oriented in any direction with respect to a flow path of the fluid 110. For example, in FIG. 13, a flat side 193 of the triangle 186 may be disposed perpendicular or parallel to the flow path of the fluid 110. Further, a point 193 of the triangle 186 may be disposed upstream of the flat side 190 or downstream from the flat side 190, with respect to the flow path of the fluid 110. The same principle may apply to any of the shapes illustrated in FIGS. 10-14, or any other shape of the connector(s) 112, in accordance with the present disclosure. The shape and/or orientation of the connectors 112 may be determined for various embodiments based on desired stiffness provided by the connectors 112 and desired heat distribution efficiency provided by the connectors 112, among other factors. For example, the connectors 112 may be elongated and/or tapered in a certain orientation with respect to the flow of the fluid 110 to help orient and distribute the fluid flow for better heat transfer, e.g., to help improve coupling of hot spots. Further, the connectors 112 may be angled, shaped, spaced, or positioned to help control the fluid flow and distribution of heat within the fluid 110, or to provide enhanced stiffness in areas of the cylinder liner 24 that endure a greater side force from the piston 38.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
a cylinder liner for a reciprocating engine, wherein the cylinder liner has a piston bore configured to receive a piston, and the cylinder liner comprises a first end having a flange configured to interface with a cylinder head; and
a cooling passage configured to receive a fluid to cool the cylinder liner, wherein a first portion of the cooling passage is defined by and disposed within the flange.

2. The system of claim 1, wherein the flange defines a portion of an inlet or outlet of the cooling passage, and the portion of the inlet or outlet extends radially into the flange relative to a longitudinal axis of the cylinder liner.

3. The system of claim 2, wherein the first portion of the cooling passage extends in a longitudinal direction from the inlet or outlet relative to the longitudinal axis.

4. The system of claim 1, wherein the first portion of the cooling passage extends circumferentially 360 degrees within the flange about a longitudinal axis of the cylinder liner.

5. The system of claim 1, wherein the cylinder liner comprises an annular body portion that extends away from the flange in a longitudinal direction relative to a longitudinal axis of the cylinder liner, and the cooling passage comprises a second portion disposed within the annular body portion that extends from the first portion of the cooling passage.

6. The system of claim 5, wherein the second portion of the cooling passage extends within the annular body portion in both a longitudinal direction and a circumferential direction relative to the longitudinal axis of the cylinder liner.

7. The system of claim 6, wherein a portion of the cylinder liner defining the first or second portions of the cooling passage within the cylinder liner has a first surface and a second surface disposed opposite the first surface, the first surface being located closer to a surface of the cylinder liner that interfaces with the piston, and wherein the cylinder liner comprises a plurality of structures spaced apart and extending radially relative to the longitudinal axis of the cylinder liner between the first and second surfaces, the plurality of structures being located circumferentially 360 degrees about the longitudinal axis of the cylinder liner, and the plurality of structures is configured to distribute a flow of the fluid and to improve heat transfer about the cylinder liner while maintaining local liner stiffness.

8. The system of claim 6, comprising a cylinder block disposed about the cylinder liner, wherein the cylinder block and the cylinder liner define a third portion of the cooling passage about the annular body portion of the cylinder liner that extends from and is fluidly coupled with the second portion of the cooling passage.

9. The system of claim 8, wherein the third portion of the cooling passage extends about the annular body portion in both the longitudinal direction and the circumferential direction relative to the longitudinal axis of the cylinder liner.

10. The system of claim 9, wherein the cylinder liner comprises a plurality of structures spaced apart and extending radially relative to the longitudinal axis of the cylinder liner between the cylinder liner and the cylinder block, the plurality of structures being located circumferentially 360 degrees about the longitudinal axis of the cylinder liner, and the plurality of structures is configured to distribute a flow of the fluid and to improve heat transfer about the cylinder liner.

11. The system of claim 10, wherein the plurality of structures comprises a plurality of rows of the structures disposed about the cylinder liner, each structure within a respective row is aligned in the circumferential direction about the cylinder liner, and adjacent structures of adjacent rows are aligned in the longitudinal direction.

12. The system of claim 10, wherein the plurality of structures comprises a plurality of rows of the structures disposed about the cylinder liner and adjacent structures of adjacent rows are staggered with respect to each other in the circumferential direction.

13. The system of claim 1, comprising the reciprocating engine having the cylinder liner and the cooling passage.

14. A system, comprising:
a reciprocating engine, comprising:
a cylinder liner for a reciprocating engine;
a piston disposed within the cylinder liner, wherein the piston is configured to move between a top dead center position and a bottom dead center position relative to the cylinder liner; and
a cooling passage configured to receive a fluid to cool the cylinder liner above the top dead center position, at the top dead center position, and below the top dead center position.

15. The system of claim 14, comprising a plurality of structures disposed within the cooling passage, wherein the plurality of structures is configured to provide stiffness to the cylinder liner, diffuse a flow of the fluid, and help improve uniformity of heat transfer circumferentially, radially, longitudinally, or a combination thereof, about the cylinder liner.

16. The system of claim 14, wherein the cooling passage comprises:
a first passage portion disposed within a flange of the cylinder liner, wherein the flange is disposed at a first end of the cylinder liner proximate a cylinder head of the reciprocating engine; and
a second passage portion disposed within a liner body of the cylinder liner, wherein the liner body extends longitudinally away from the flange of the cylinder liner with respect to a longitudinal axis of the cylinder liner.

17. The system of claim 14, comprising:
a cylinder block disposed around the cylinder liner;
wherein the cylinder liner comprises a flange configured to contact a surface defining a bore of the cylinder block for positioning the cylinder liner within the cylinder block, wherein a gap resides between an outer surface of the cylinder liner and an inner surface of the cylinder block, and wherein a portion of the cooling passage is disposed within the gap.

18. A system, comprising:
a cylinder liner for a reciprocating engine, wherein the cylinder liner comprises:
a piston bore configured to receive a piston;
a first end having a flange configured to interface with a cylinder head; and
an annular body portion extending away from the flange at the first end to a second end in a longitudinal direction relative to a longitudinal axis of the cylinder liner;
a cylinder block disposed about the cylinder liner;
a continuous cooling passage that extends in both the longitudinal direction and a circumferential direction relative to the longitudinal axis within the flange, within a portion of the annular body, and between a cavity defined by both the cylinder liner and the cylinder block; and
a plurality of structures extending within the continuous cooling passage.

19. The system of claim 18, wherein the plurality of structures extend in a radial direction, an axial direction, a circumferential direction, or a combination thereof, wherein each of the plurality of structures comprises a cross-sectional shape of a circle, a square, a rectangle, a triangle, a tear drop, or an airflow relative to a flow of fluid through the continuous cooling passage, and wherein the plurality of structures is configured to extend within portions of the continuous cooling passage disposed within the flange of the cylinder liner, within the annular body of the cylinder liner, or both.

20. The system of claim 18, comprising a sleeve bearing the plurality of structures, wherein the sleeve is configured to be disposed between the cylinder liner and the cylinder block such that the plurality of structures are disposed between the cylinder liner and the cylinder block.
